(19) United States
(12) Patent Application Publication
(10) Pub. No.: US 2019/0246232 A1
(43) Pub. Date: Aug. 8, 2019

(54) ADJUSTING AUDIO PACKET OUTPUT PARAMETERS BASED ON A USER POSITION RELATIVE TO A WIRELESS DEVICE

(71) Applicant: QUALCOMM Incorporated, San Diego, CA (US)

(72) Inventors: Anish SINGH, Bangalore (IN); Chirag Manojkumar KHARVAR, Bangalore (IN); Himanshu RAWAT, Nainital (IN)

(21) Appl. No.: 15/891,067

(22) Filed: Feb. 7, 2018

(51) Int. Cl. H04S 7/00; H04R 3/12; H04W 4/80

(52) U.S. Cl. CPC H04S 7/303; H04W 4/80; H04R 3/12

(57) ABSTRACT

In an aspect of the disclosure, a method, a computer-readable medium, and an apparatus are provided. The apparatus may receive at least one signal from one or more second devices. The at least one signal may be received via a short-range communication protocol. The apparatus may determine a position of each of the one or more second devices relative to the first device based at least in part on a reference vector associated with each of the at least one signal and a reference point associated with either the first device or each of the one or more second devices. The apparatus may adjust one or more output parameters based at least in part on the position of each of the one or more second devices relative to the first device. The apparatus may output one or more audio packets using the adjusted one or more output parameters.

### BACKGROUND

### Field

The present disclosure relates generally to communication systems, and more particularly, to a mechanism for adjusting one or more audio packet output parameters.

### Background

A wireless personal area network (WPAN) is a personal, short-range wireless network for interconnecting devices centered around a specific distance from a user. WPANs have gained popularity because of the flexibility and convenience in connectivity that WPANs provide. WPANs based on short-range communication protocols (e.g., a Bluetooth® (BT) protocol, a BT Low Energy (BLE) protocol, a Zigbee® protocol, etc.) provide wireless connectivity to peripheral devices within a specific distance (e.g., 5 meters, 10 meter, 20 meters, 100 meters, etc.) from a central device.

In certain scenarios, short-range communication may be used stream audio packets from a central device (e.g., an access point, a first wireless speaker, a smart phone, a lap top, a tablet device, etc.) that are output at a peripheral device (e.g., a second wireless speaker). In certain scenarios, adjusting one or more output parameters associated with the audio packets may be beneficial.

Thus, there exists a need to enable a wireless device to output one or more audio packets using at least one adjusted output parameter.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Wireless speakers are loudspeakers which receive audio packets and/or audio signals using radio frequency (RF) waves rather than over audio cables. There are various types of wireless speakers, such as BT speakers and Wi-Fi speakers, just to name a few.

BT speaker(s) may be used as companion devices to BT-enabled central devices, e.g., such as smart phones, laptop computers, and/or tablet devices. A BT speaker may be “paired” with a BT-enabled central device via a short-range communication link through which audio playback or streaming may be enabled. Audio streaming may refer to a technique in which audio packets are sent (e.g., in compressed form) from a first device to a second device, which outputs the audio packets rather than saving the audio packets to a hard drive. Because the audio packets are received in a continuous stream, the second device may output the audio packets as they arrive. RF frequencies, such as the BT frequency band (e.g., 2.4 GHz) and/or the BLE frequency band (e.g., 2.4 GHz), may be used to transmit audio packets from the BT-enabled central to the receiving BT speaker (e.g., peripheral device).

In contrast to a BT speaker, a Wi-Fi speaker may connect to a home network and communicate over a transmission control protocol (TCP)/internet protocol (IP). A Wi-Fi speaker may be able to communicate over larger distances than BT speakers, and hence, Wi-Fi speakers may be used for “whole house” audio systems in which wireless speakers in different rooms communicate with one another using the Wi-Fi protocol. RF frequencies, such as an IEEE 802.11 frequency band (e.g., 2.4 GI-Iz, 3.6 GHz, 4.9 GHz, 5 GHz, 5.9 GHz, etc.), may be used to transmit audio packets from the Wi-Fi access point and/or a central Wi-Fi speaker to one or more peripheral Wi-Fi speakers.

While wireless speakers provide the advantage of audio streaming without the inconvenience of wires, as a listener moves away from a wireless speaker, the perceived quality of sound may decrease. For example, assume a listener is streaming music on a wireless speaker that is located in the kitchen, and while doing household chores, the listener moves from the kitchen to the bedroom. Initially, when the listener is in the kitchen the output parameters (e.g., volume, gain, equalization, etc.) of the audio output may be perceived as pleasant by the listener. However, as the listener moves towards the bedroom, the listener may be unable to hear the audio output and/or certain frequencies may sound distorted as walls and furniture cause the audio frequencies to attenuate at different levels. In other words, the sound quality perceived by the listener may be reduced as the listener moves around the house.

Thus, there is a need to enable a wireless speaker to output audio packets in a way that increases the quality of the sound perceived by a listener moving towards and/or away from the wireless speaker.

The present disclosure provides a solution by enabling a wireless speaker to adjust audio packet output parameters (e.g., volume, equalization, gain, etc.) based on the position of the listener, which may be determined using signals received from a wireless device (e.g., smartphone, wearable device, etc.) located on the listener's person. By adjusting one or more output parameters based on a listener's position, the quality of sound perceived by listener may be increased.

In an aspect of the disclosure, a method, a computer-readable medium, and an apparatus are provided. The apparatus may include a first device (e.g., a wireless speaker) with a plurality of output devices. In certain configurations, the apparatus may receive at least one signal from one or more second devices. In certain aspects, the at least one signal may be received via a short-range communication protocol. In certain other configurations, the apparatus may determine a position of each of the one or more second devices relative to the first device based at least in part on a reference vector associated with each of the at least one signal and a reference point associated with either the first device or each of the one or more second devices. In certain other configurations, the apparatus may adjust one or more output parameters based at least in part on the position of each of the one or more second devices relative to the first device. In certain other configurations, the apparatus may output one or more audio packets using the adjusted one or more output parameters.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN and wireless local area network (WLAN) in accordance with certain aspects of the disclosure.

FIG. 2 is block diagram of a wireless device in accordance with certain aspects of the disclosure.

FIG. 3 illustrate a wireless network that supports an adjustment of output parameters in accordance with certain aspects of the disclosure.

FIGS. 4A and 4B are a flowchart of a method of wireless communication.

FIG. 5 is a conceptual data flow diagram illustrating the data flow between different means/components in an exemplary apparatus.

FIG. 6 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. Such apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

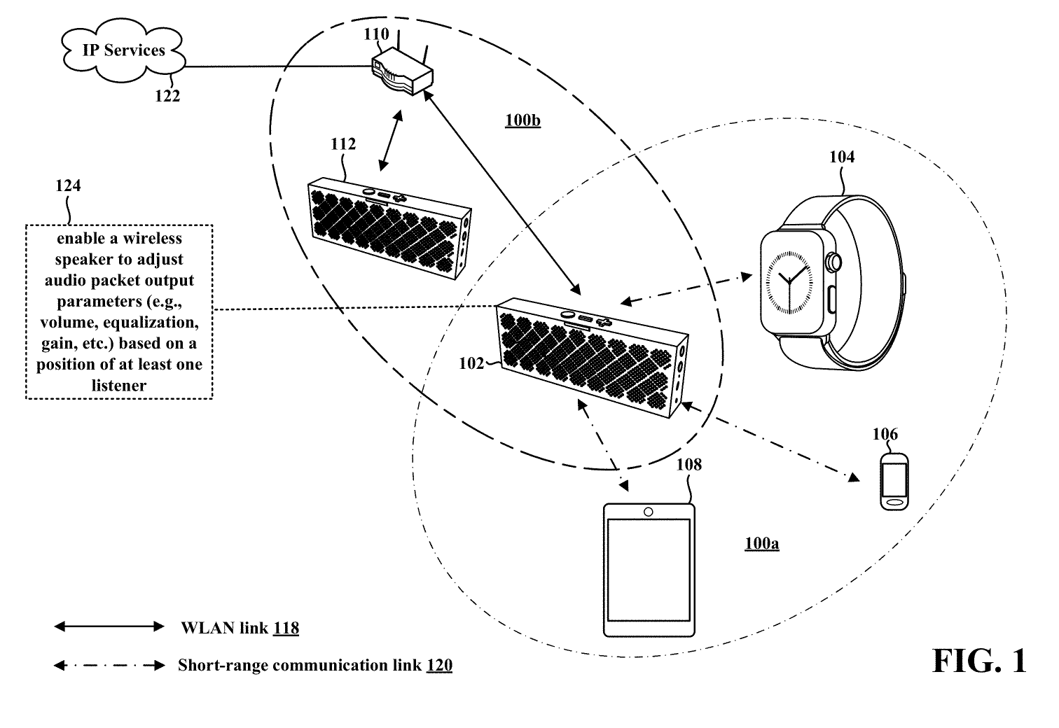

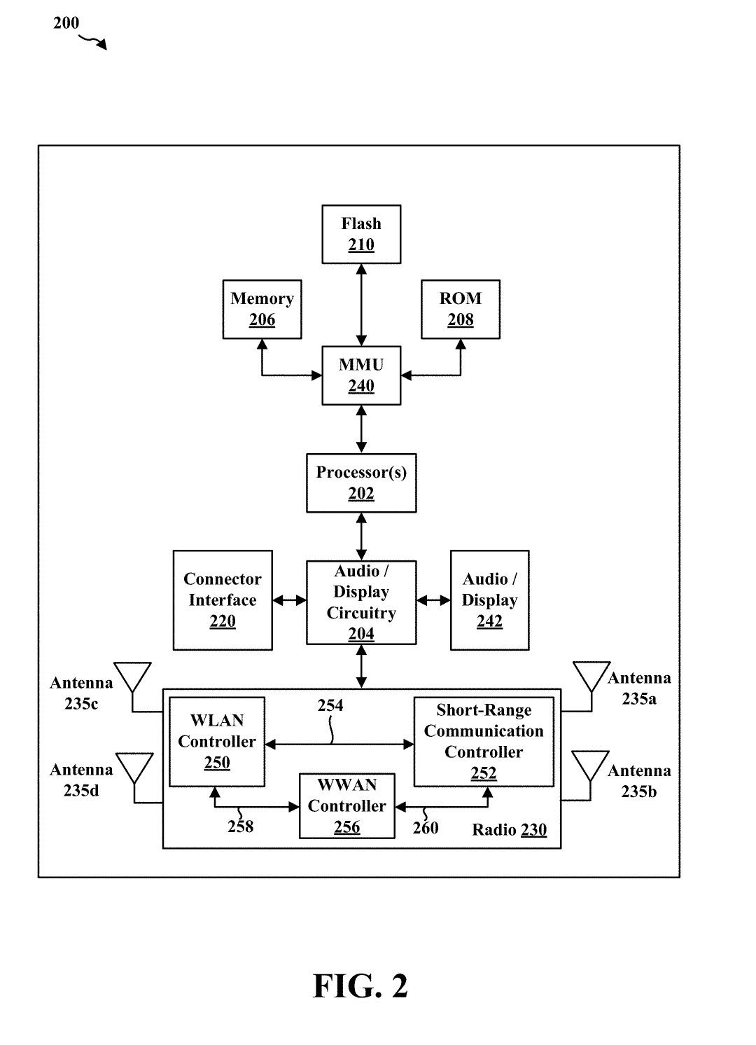

FIG. 1 illustrates an example WPAN 100a and a WLAN 100b in accordance with certain aspects of the disclosure. A central device 102 may be part of both the WPAN 100a and the WLAN 100b, and thus be configured to operate multiple radio interfaces corresponding to multiple RATs (e.g., Wi-Fi, BT, BLE, etc.) concurrently. For example, a BT radio interface at the central device 102 may be used for communications within the WPAN 100a, and a Wi-Fi radio interface at the central device 102 may be used for communications within the WLAN 100b. Shared antennas for different RATs may be used by the central device 102, e.g., as discussed below with reference to FIG. 2. The shared antennas may be used for, e.g., short-range communication via a short-range communication link 120 and Wi-Fi communication via a WLAN link 118. In certain aspects, short-range communication and Wi-Fi communication may be performed using the same frequency band (e.g., 2.4-2.4835 GHz frequency range, 5 GHz frequency range, etc.). In certain other aspects, short-range communication and Wi-Fi communication may be performed using different frequency bands.

Examples of the central device 102 include a wireless speaker, a cellular phone, a smart phone, a session initiation protocol (SIP) phone, a mobile station (STA), a laptop computer, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similarly functioning device that is configured for audio streaming.

Within the WPAN 100a, the central device 102 may communicate with one or more peripheral devices 104, 106, 108 using a short-range communications protocol (e.g., BT protocol, BLE protocol, Zigbee® protocol, etc.). Examples of the one or more peripheral devices 104, 106, 108 may include wireless earbuds, a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device (e.g., smart watch, smart band, etc.), or any other similarly functioning device that may provide tracking information and/or transmit audio packets to the central device 102. Although the central device 102 is illustrated in communication with three peripheral devices 104, 106, 108 in the WPAN 100a, the central device 102 may communicate with more or fewer than three peripheral devices without departing from the scope of the present disclosure.

Within the WLAN 100b, the central device 102 may communicate with a second device 110 and/or a third device 112 using a Wi-Fi communication protocol (e.g., IEEE 802.11 protocol, etc.). The second device 110 may be configured to connect to IP Services 122. The IP Services 122 may include the Internet, an intranet, an IP Multimedia Subsystem (IMS), a PS Streaming Service, and/or other IP services. The second device 110 may communicate information (e.g., audio packets) between the central device 102 and IP Services 122. Examples of the second device 110 include a Wi-Fi router and/or a Wi-Fi AP. Wi-Fi communications may be performed using time slots in the 5 GHz unlicensed spectrum. When communicating in an unlicensed frequency spectrum, the central device 102 and/or the second device 110 may perform a clear channel assessment (CCA) prior to communicating with one another in order to determine whether the channel is available. In certain implementations, the central device 102 may communicate with the third device 112 via the second device 110, which relays information (e.g., audio packets) from the central device 102 to the third device 112, and vice versa.

Referring again to FIG. 1, in certain aspects, the central device 102 may be configured to enable a wireless speaker to adjust audio packet output parameters (e.g., volume, equalization, gain, etc.) based on a position of at least one listener (124), e.g., as described below in connection with any of FIGS. 2-6.

FIG. 2 is block diagram of a wireless device 200 in accordance with certain aspects of the disclosure. The wireless device 200 may correspond to, e.g., the central device 102, one of peripheral devices 104, 106, 108, the second device 110, and/or the third device 112 described above in connection with FIG. 1. In certain aspects, the wireless device 200 may include a wireless speaker or any other wireless device configured to stream audio packets.

As shown in FIG. 2, the wireless device 200 may include a processing element, such as processor(s) 202, which may execute program instructions for the wireless device 200. The wireless device 200 may also include audio/display circuitry 204 which may perform audio processing and/or graphics processing and provide audio signals, audio packets, and/or display signals to the audio/display 242 (e.g., speakers, display screen, etc.). The processor(s) 202 may also be coupled to a memory management unit (MMU) 240, which may be configured to receive addresses from the processor(s) 202 and translate the addresses to address locations in memory (e.g., memory 206, ROM 208, Flash memory 210) and/or to address locations in other circuits or devices, such as the audio/display circuitry 204, radio 230, connector interface 220, and/or audio/display 242. The MMU 240 may be configured to perform memory protection and page table translation or set up. In some embodiments, the MMU 240 may be included as a portion of the processor(s) 202. In certain configurations, one or more of the processor(s) 202, memory 206, ROM 208, and/or Flash memory 210 may be configured to access one or more look-up table(s) that includes a correlation of one or more reference vectors (e.g., angle of arrival (AoA), angle of departure (AoD), received signal strength indicator (RSSI), a transmission power level, etc.) associated with a signal received from a transmitting device (e.g., one or more of the peripheral devices 104, 106, 108 shown in FIG. 1) to one or more output parameters (e.g., intensity, loudness, gain, equalization, bass level, treble level, etc.) associated with the output of at least one audio packet by the audio/display 242.

As shown, the processor(s) 202 may be coupled to various other circuits of the wireless device 200. For example, the wireless device 200 may include various types of memory 206, a connector interface 220 (e.g., for coupling to the computer system), the audio/display 242, and wireless communication circuitry (e.g., for Wi-Fi, BT, BLE, cellular, etc.). The wireless device 200 may include a plurality of antennas 235a, 235b, 235c, 235d, for performing wireless communication with, e.g., wireless devices in a WPAN or WLAN. The different phases of a signal that are respectively received by each of the antennas 235a, 235b, 235c, 235d may be used by the processor(s) 202, the memory 206, the ROM 208, and/or the Flash memory 210 to determine the AoA and/or AoD of a received tracking signal.

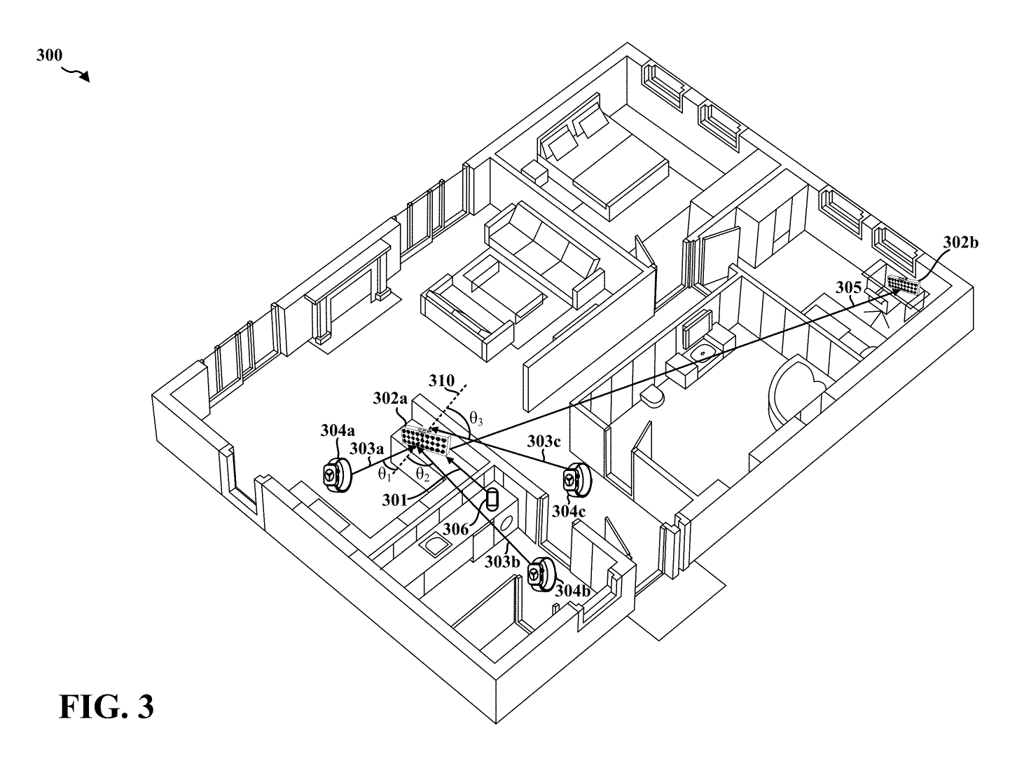

In certain aspects, the wireless device 200 may include hardware and software components (a processing element) configured to enable a wireless speaker (e.g., audio/display 242) to adjust audio packet output parameters (e.g., volume, equalization, gain, bass, treble, etc.) based on a position of the listener, e.g., using the techniques described below in connection with any FIGS. 3-6.

The wireless device 200 may be configured to implement part or all of the techniques described below in connection with any of FIGS. 3-6, e.g., by executing program instructions stored on a memory medium (e.g., a non-transitory computer-readable memory medium) and/or through hardware or firmware operation. In other embodiments, the techniques described below in connection with any of FIGS. 3-6 may be at least partially implemented by a programmable hardware element, such as an field programmable gate array (FPGA), and/or an application specific integrated circuit (ASIC).

In certain aspects, radio 230 may include separate controllers configured to control communications for various respective RAT protocols. For example, as shown in FIG. 2, radio 230 may include a WLAN controller 250 configured to control WLAN communications, a short-range communication controller 252 configured to control short-range communications, and a WWAN controller 256 configured to control WWAN communications. In certain aspects, the wireless device 200 may store and execute a WLAN software driver for controlling WLAN operations performed by the WLAN controller 250, a short-range communication software driver for controlling short-range communication operations performed by the short-range communication controller 252, and/or a WWAN software driver for controlling WWAN operations performed by the WWAN controller 256.

In certain implementations, a first coexistence interface 254 (e.g., a wired interface) may be used for sending information between the WLAN controller 250 and the short-range communication controller 252. In certain other implementations, a second coexistence interface 258 may be used for sending information between the WLAN controller 250 and the WWAN controller 256. In certain other implementations, a third coexistence interface 260 may be used for sending information between the short-range communication controller 252 and the WWAN controller 256.

In some aspects, one or more of the WLAN controller 250, the short-range communication controller 252, and/or the WWAN controller 256 may be implemented as hardware, software, firmware or some combination thereof.

In certain configurations, the WLAN controller 250 may be configured to communicate with at least one second device in a WLAN using a WLAN link using all of the antennas 235a, 235b, 235c, 235d. In certain other configurations, the short-range communication controller 252 may be configured to communicate with at least one second device in a WPAN using one or more of the antennas 235a, 235b, 235c, 235d. In certain other configurations, the WWAN controller 256 may be configured to communicate with at least one second device in a WWAN using all of the antennas 235a, 235b, 235c, 235d.

In certain configurations, the wireless device 200 may include a wireless speaker. Wireless speakers are loudspeakers which receive audio packets and/or audio signals using RF waves rather than over audio cables. There are various types of wireless speakers, such as BT speakers and Wi-Fi speakers, just to name a few.

BT speaker(s) may be used as companion devices to BT-enabled central devices, e.g., such as smart phones, laptop computers, and/or tablet devices. A BT speaker may be “paired” with a BT-enabled central device via a short-range communication link through which audio playback or streaming may be enabled. Audio streaming may refer to a technique in which audio packets are sent (e.g., in compressed form) from a first device to a second device, which outputs the audio packets rather than saving the audio packets to a hard drive. Because the audio packets are received in a continuous stream, the second device may output the audio packets as they arrive. RF frequencies, such as the BT frequency band (e.g., 2.4 GHz) and/or the BLE frequency band (e.g., 2.4 GHz), may be used to transmit audio packets from the BT-enabled central to the receiving BT speaker (e.g., peripheral device).

In contrast to a BT speaker, a Wi-Fi speaker may connect to a home network and communicate over a TCP/IP. A Wi-Fi speaker may be able to communicate over larger distances than BT speakers, and hence, Wi-Fi speakers may be used for “whole house” audio systems in which wireless speakers in different rooms communicate with one another using the Wi-Fi protocol. RF frequencies, such as an IEEE 802.11 frequency band (e.g., 2.4 GHz, 3.6 GHz, 4.9 GHz, 5 GHz, 5.9 GHz, etc.), may be used to transmit audio packets from the Wi-Fi access point and/or a central Wi-Fi speaker to one or more peripheral Wi-Fi speakers.

While wireless speakers provide the advantage of audio streaming without the inconvenience of wires, as a listener moves away from a wireless speaker, the perceived quality of sound may decrease. For example, assume a listener is streaming music on a wireless speaker that is located in the kitchen, and while doing household chores, the listener moves from the kitchen to the bedroom. Initially, when the listener is in the kitchen the volume and equalization of the audio output may be perceived as pleasant by the listener. However, as the listener moves towards the bedroom, the listener may be unable to hear the audio output and/or the equalization may sound distorted as walls and furniture cause different frequencies to attenuate at different amounts. Since all sound frequencies do not attenuate equally over distance and obstacles, the sound the listener hears from the bedroom may sound distorted, and hence, the perceived audio quality may be reduced. In an attempt to increase the quality of perceived sound in the bedroom, the listener may adjust the equalizer (e.g., a circuit, component, and/or device that may be used to adjust the balance between frequency components within an electronic signal) on the wireless speakers to amplify frequencies which attenuate more than others. However, continually adjusting the equalizer while moving around in the house may be challenging for the listener.

Thus, there is a need to enable a wireless speaker to output audio packets in a way that increases the quality of the sound perceived by a listener moving towards and/or away from the wireless speaker.

The present disclosure provides a solution by enabling a wireless speaker to adjust audio packet output parameters (e.g., volume, equalization, gain, etc.) based on the position of the listener, which may be determined using signals received from a wireless device (e.g., smartphone, wearable device, etc.) located on the listener's person. By adjusting one or more output parameters based on a listener's position with respect to the wireless speaker, the quality of sound perceived by one or more listeners may be increased, e.g., as described below in connection with any of FIGS. 3-6.

FIG. 3 illustrate a wireless network 300 that supports wireless communications between a first device 302a (e.g., a wireless speaker), a plurality of transmitting devices 304a, 304b, 304b, a third device 306, and a fourth device 302b (e.g., wireless speaker) in accordance with certain aspects of the disclosure. The wireless network 300 may include one or more of a WPAN and a WLAN located within a home.

The first device 302a may correspond to, e.g., the central device 102, the wireless device 200, the apparatus 500/502′. The first transmitting device 304a may correspond to, e.g., the peripheral device 104, 106, 108, the wireless device 200, the at least one second device 550. The second transmitting device 304b may correspond to, e.g., the peripheral device 104, 106, 108, the wireless device 200, the at least one second device 550. The third transmitting device 304c may correspond to, e.g., the peripheral device 104, 106, 108, the wireless device 200, the at least one second device 550. The third device 306 may correspond to, e.g., the peripheral device 104, 106, 108, the second device 110, the wireless device 200, the third device 555. The fourth device 302b may correspond to, e.g., third device 112, the wireless device 200, the fourth device 560.

For illustrative purposes, each of the first device 302a and the fourth device 302b are depicted as a wireless speaker. However, the first device 302a and the fourth device 302b are not limited to wireless speakers or to being the same type of device. Instead, the first device 302a and the fourth device 302b may be any wireless device that is able to stream audio packets (e.g., smart television, smart phone, laptop, tablet device, etc.) and adjust at least one output parameter of the audio packets based on the position of the transmitting devices 304a, 304b, 304c. Although two wireless speakers are depicted in FIG. 3, a single wireless speaker or more than two wireless speakers may be included in the wireless network 300 without departing from the scope of the present disclosure.

Furthermore, each of the transmitting devices 304a, 304b, 304c is depicted as a smart watch in in FIG. 3. However, the transmitting devices 304a, 304b, 304c are not limited to being a smart watch or to being the same type of device. Instead, the transmitting devices 304a, 304b, 304c may be any wireless device that may be carried on a listener's person and is able to transmit tracking signals 303a, 303b, 303c. For example, the first transmitting device 304a may be a smart watch, the second transmitting device 304b may also be a smart watch, and the third transmitting device 304c may be a smart phone. Although three transmitting devices 304a, 304b, 304c are depicted in FIG. 3, fewer than three transmitting devices or more than three transmitting devices may be included in the wireless network 300 without departing from the scope of the present disclosure.

In addition, the third device 306 is illustrated as a smart phone. However, the third device 306 may include any other type of device that may be used to transmit audio packets to the first device 302a. For example, the third device 306 may include a tablet device, a laptop, or an AP when the first device 302a includes a Wi-Fi speaker. When the third device 306 includes an AP, the third device 306 may be configured to relay a signal 305 from the first device 302a to the fourth device 302b, where the signal 305 instructs the fourth device 302b to turn on or off and/or which output parameters to adjust.

Referring to FIG. 3, the first device 302a may receive a signal 301 from the third device 306. The signal 301 may include one or more audio packets that may be output by the first device 302a. In certain configurations, the signal 301 may include more than one signal.

In certain configurations, the first device 302a may receive a tracking signal 303a, 303b, 303c from each of the transmitting devices 304a, 304b, 304c. The tracking signals 303a, 303b, 303c may be communicated using BT and/or BLE communications, and may be used by the first device 302a and/or the fourth device 302b to track a position of the transmitting devices 304a, 304b, 304c. In certain configurations, each of the tracking signals 303a, 303b, 303c may indicate a respective transmit power level that is used by the transmitting devices 304a, 304b, 304c when sending the tracking signals 303a, 303b, 303c.

Using the received tracking signals 303a, 303b, 303c, the first device 302a may determine a position of each of the transmitting devices 304a, 304b, 304c relative to the first device 302a. For example, the positions may be determined based at least in part on a reference vector (e.g., AoA, AoD, direction, RSSI, transmit power level, etc.) associated with each of the tracking signals 303a, 303b, 303c, and a reference point 310 (e.g., a midline) associated with the first device 302a. Additionally and/or alternatively, a reference point (not shown in FIG. 3) associated with each of the transmitting devices 304a, 304b, 304c may be used in combination with the reference vector to determine the respective positions of the transmitting devices 304a, 304b, 304c.

In configurations in which the reference vector includes the AoA (e.g., θ₁, θ₂, θ₃) and/or AoD (not shown), the first device 302a may determine a direction (e.g., angular direction) in which each of the transmitting devices 304a, 304b, 304c travels with respect to the first device 302a based at least in part on at least one of the AoA and/or the AoD.

In certain aspects, the first device 302a may determine the AoA and/or AoD of each of the tracking signals 303a, 303b, 303c based on the signal phase that is received at each antenna (e.g., antenna 235a, 235b, 235c, 235d in FIG. 2) in the first device's 302a antenna array. The phase differences between each antenna may be converted to an AoA measurement and/or an AoD measurement by the first device 302a.

Consider, for example, an antenna array with two antennas spaced apart by one-half the wavelength of the first tracking signal 303a (e.g., an RF wave). If the RF wave is incident upon the antenna array at boresight (e.g., along the axis of symmetry of the antenna array), the first tracking signal 303a may arrive at each antenna concurrently, thus yielding a 0° phase-difference that is measured between the two antennas. A 0° phase-difference may be equivalent to 01=0°. If the RF wave is incident upon the antenna array at broadside (e.g., perpendicular to the axis of symmetry of the antenna array), then a 180° phase difference between the antennas in the antenna array may correspond to θ₁=90°.

In certain implementations, the first device 302a may determine the AoA and/or AoD from a look-up table that includes a correlation of the determined phase differences of a signal received by the antennas and the AoA/AoD of the signal. The look-up table may be maintained at the first device 302a or remote from the first device 302a.

Based at least in part on the AoA=θ₁ of the first tracking signal 303a, the first device 302a may determine whether the first transmitting device 304a is positioned to the left (e.g., 0°<θ₁<180°) or to the right (e.g., −180°<θ₁<0°) of the reference point 310 (e.g., the x-y plane) associated with the first device 302a.

In configurations in which the reference vector includes the transmit power level and/or the RSSI, the first device 302a may further determine the position of each of the transmitting devices 304a, 304b, 304c by determining a respective distance to each of the transmitting devices 304a, 304b, 304c based at least in part on one or more of the transmit power level and/or the RSSI.

The RSSI associated with each of the tracking signals 303a, 303b, 303c may be determined based on the signal power that is detected by the first device 302a. In certain configurations, the respective transmit power level that is indicated by each of the tracking signals 303a, 303b, 303c as well as the signal power may be used to determine the RSSI. The first device 302a may access a look-up table that correlates distances to RSSIs in order to determine the distances of the transmitting devices 304a, 304b, 304c. Additionally and/or alternatively, the RSSI may be used to indicate a linear direction that a listener is moving with respect to the first device 302a. For example, if at time t₀, the first device 302a determines the first tracking signal 303a has an RSSI equal to 10 for first tracking signal 303a, and at time t₁ the first tracking signal 303a has an RSSI equal to 1, the first device 302a may determine that the first transmitting device 304a is moving towards the first device 302a.

Based on the position determined using one or more of the AoA, AoD, transmit power level, and/or the RSSI, the first device 302a may adjust one or more output parameters used for outputting the audio packets. For example, the one or more output parameters may be adjusted based at least in part on the angular direction and/or linear direction in which each of the transmitting devices 304a, 304b, 304c travels with respect to the first device 302a, and/or the distance of each of the transmitting devices 304a, 304b, 304c to the first device 302a. The first device 302a may adjust the output parameters (e.g., volume, the set or subset of output devices used to output the audio packets, the gain, the equalization, the bass level, the treble level, etc.) based on a look-up table that includes a correlation of angular direction, linear direction, and/or distance to various output parameters. The look-up table may be maintained at the first device 302a or remote from the first device 302a.

In certain implementations, the first device 302a may determine which of the transmitting devices 304a, 304b, 304c is nearest to the first device 302a. Based on the distance to the nearest transmitting device (e.g., the first transmitting device 304a in FIG. 3), the first device 302a may adjust the one or more output parameters using a volume threshold.

For example, if at time t₀, the first device 302a determines that the first transmitting device 304a is 20 feet away, the second transmitting device is 35 feet away, and that the third transmitting device 304c is 55 feet away, the first device 302a may output the audio packets at a volume level v₂₀ correlated with a distance of 20 feet. If at time t₁, the first device 302a determines that the first transmitting device 304a is 10 feet away, the second transmitting device remains 35 feet away, and that the third transmitting device 304c remains 55 feet away, the first device 302a may adjust the volume of the audio packets to volume level v₁₀ correlated with a distance of 10 feet, where v₁₀<v₂₀. By reducing the volume level used to output the audio packets when the first transmitting device 304a (e.g., the first listener) moves closer to the first device 302a, the nearest listener may not perceive the output of the audio packets as being too loud, and hence, the sound quality perceived by the nearest listener may be improved.

In certain implementations, the first device 302a may determine an average distance to the transmitting devices 304a, 304b, 304c. Based on the average distance to the transmitting devices 304a, 304b, 304c, the first device 302a may use an average of the respective output parameters associated with the transmitting devices 304a, 304b, 304c. Output parameters may be selected by each listener may select (e.g., using an application on a smart device that is associated with one or more the first device 302a or fourth device 302b) such that audio packets are output using parameters the listener finds desirable based on distance, location, etc. Additionally and/or alternatively, the output parameters associated with each user may be may be preconfigured in one or more look-up table(s) accessible by the first device 302a and/or the fourth device 302b.

For example, if at time t₀, the first device 302a determines that the average distance to the transmitting devices 304a, 304b, 304b is 55 feet, the first device 302a may output the audio packets at one or more of a volume level v₅₅, a gain level g₅₅, an equalization level e₆₅, a bass level b₆₅, and/or a treble level s₆₅ correlated with a distance of 55 feet. If at time t₁, the first device 302a determines that the average distance to the transmitting devices 304a, 304b, 304b is now 50 feet, the first device 302a may adjust the output parameters of the audio packets to a volume level v₅₀, a gain level g₅₀, an equalization level e₅₀, a bass level b₅₀, and/or a treble level s₅₀ correlated with a distance of 50 feet, where v₅₀<v₅₅, g₅₀≠g₅₅, e₅₀≠e₅₅, b₅₀≠b₅₅, and s₅₀≠s₅₅. By adjusting the output parameters of the audio packets when the average distance between the transmitting devices 304a, 304b, 304c (e.g., a first listener, a second listener, and a third listener) and the first device 302a changes, the sound quality perceived by the listeners may be improved.

In certain other implementations, the first device 302a may determine the a respective distance to each of the transmitting devices 304a, 304b, 304c. Based on the respective distances, the first device 302a may adjust one or more output parameters by applying a distance dependent weighted value to determine a weighted average of the output parameters associated with the transmitting devices 304a, 304b, 304c. In certain configurations, the output parameters (e.g., user selected output parameters, preconfigured output parameters, etc.) associated with the farthest of the transmitting devices (e.g., the third transmitting device 304c) may be reduced as compared to the other user preferences associated with other transmitting devices (e.g., the first transmitting device 304a and the second transmitting device 304b). The weighted value applied to the user preferences associated with the second farthest transmitting device (e.g., the second transmitting device 304b) may also be reduced as compared to the weighted value applied to the user preferences associated with the closest transmitting device (e.g., the first transmitting device 304a).

For example, if at time t₀, the first device 302a determines that the first transmitting device 304a is 20 feet away, the second transmitting device is 30 feet away, and the third transmitting device 304c is 50 feet away, the first device 302a may apply a weighted value of 5 to the output parameters associated with the first transmitting device 304a, a weighted value of 3.33 to the output parameters associated with the second transmitting device 304b, and a weighted value of 2 to the output parameters associated with the third transmitting device 304c when determining a weighted average of the output parameters. If at time t₁, the first device 302a determines that the first transmitting device 304a is 10 feet away, the second transmitting device remains 30 feet away, and the third transmitting device 304c is 70 feet away, the first device 302a may apply a weighted value of 10 to the output parameters associated with the first transmitting device 304a, a weighted value of 3.33 to the output parameters associated with the second transmitting device 304b, and a weighted value of 1.42 to the output parameters associated with the third transmitting device 304c when determining a weighted average of the output parameters. By adjusting the output parameters of the audio packets using a weighted average based on the respective distances to the transmitting devices 304a, 304b, 304c (e.g., a first listener, a second listener, and a third listener), a larger number of listeners may not perceive the output of the audio packets as being too loud, too quiet, or having dissonant frequencies, and hence, an increase in sound quality perceived by the group of listeners may be achieved.

In certain other implementations, the first device 302a may determine whether the distances to each of the transmitting devices 304a, 304b, 304c are within a threshold range (e.g., from 0 feet to 50 feet). When the distances to each of the transmitting devices 304a, 304b, 304c are within the threshold range, the first device 302a may output the signal 301 (including the audio packets) received from the third device 306 using one or more of the techniques described above. However, when the first device 302a determines that all of the transmitting devices 304a, 304b, 304c are outside of the threshold range (e.g., the audio output may be inaudible to the listeners), the first device 302a may pause the output of the audio packets received by the third device 306. Once the first device 302a determines that at least one of the transmitting devices 304a, 304b, 304c returns within the threshold range, the first device 302a may resume the output of the audio packets using the adjusted one or more output parameters associated with the distance of the at least one transmitting devices 304a, 304b, 304c from the first device 302a.

In certain scenarios, the transmitting devices 304a, 304b, 304c may leave the threshold range of the first device 302a and enter the threshold range associated with the fourth device 302b. The first device 302a may pause the output of audio packets and power off the output devices (e.g., the speakers) upon determining that the transmitting devices 304a, 304b, 304c are outside of threshold range of the first device 302a. When the transmitting devices 304a, 304b, 304c enter the range of the fourth device 302b, the output of the audio packets may resume on the fourth device 302b. In certain configurations, the output of the audio packets at the fourth device 302b may resume where the output of the audio packets were paused at the first device 302a.

In scenarios when the first device 302a determines that the transmitting devices 304a, 304b, 304c are moving towards the fourth device 302b (while either within or outside of the threshold range of the first device 302a), the first device 302a may relay the signal 301 (including the audio packets) received from the third device 306 (e.g., via BT communication or BLE communication) to the fourth device 302b via signal 305 (e.g., via Wi-Fi communication, BT communication, BLE communication, etc.).

In certain other implementations, the first device 302a may determine that a subset of output devices (e.g., speakers located at the first device 302a) face away from the transmitting devices 304a, 304b, 304c based at least in part on the AoA (e.g., θ₁, θ₂, θ₃) and/or the AoD (not shown) of the tracking signals 303a, 303b, 303b. Consider, for example, a scenario (not illustrated in FIG. 3) in which the first device 302a includes a first subset of output devices located on a first side and a second subset of output devices located on a second side that is opposite to the first side. In this scenario, when the first device 302a determines (e.g., based on the AoA and/or AoD) that each of the transmitting devices 304a, 304b 304c are located on the first side, the first device 302a may output the audio packets using the first subset of output devices, and power off the second subset of output devices in order to conserve battery power.

By adjusting one or more output parameters based on a listener's position with respect to the first device 302a and/or the fourth device 302b using the techniques described above, the quality of sound perceived by the listener(s) may be increased, while reducing power consumption.

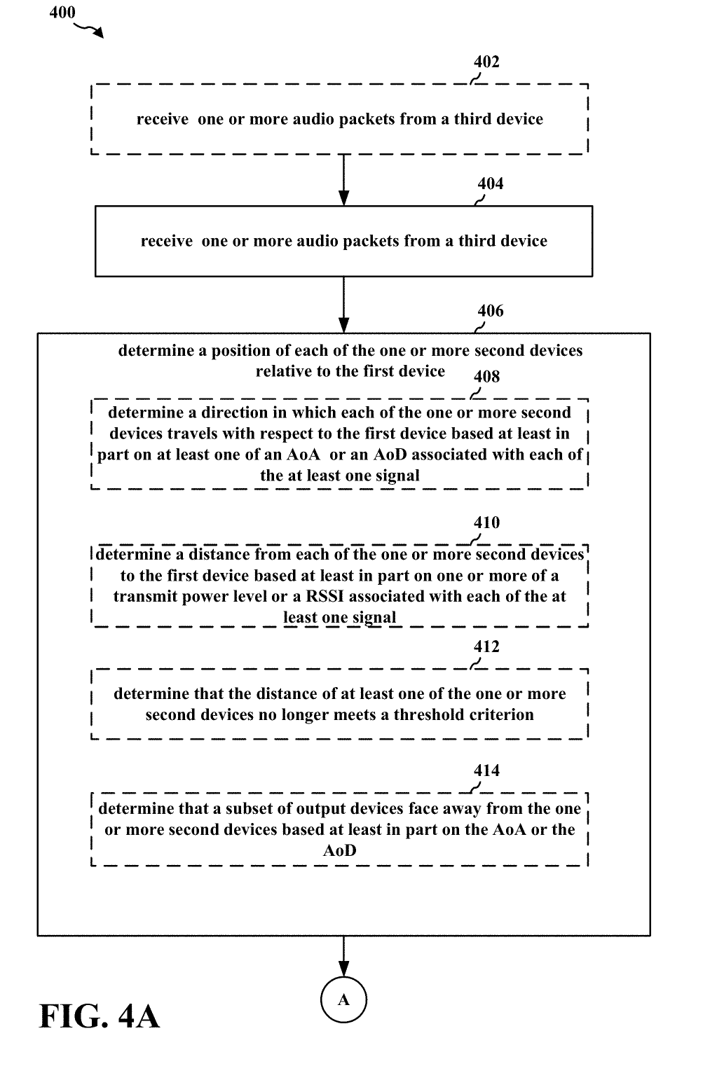

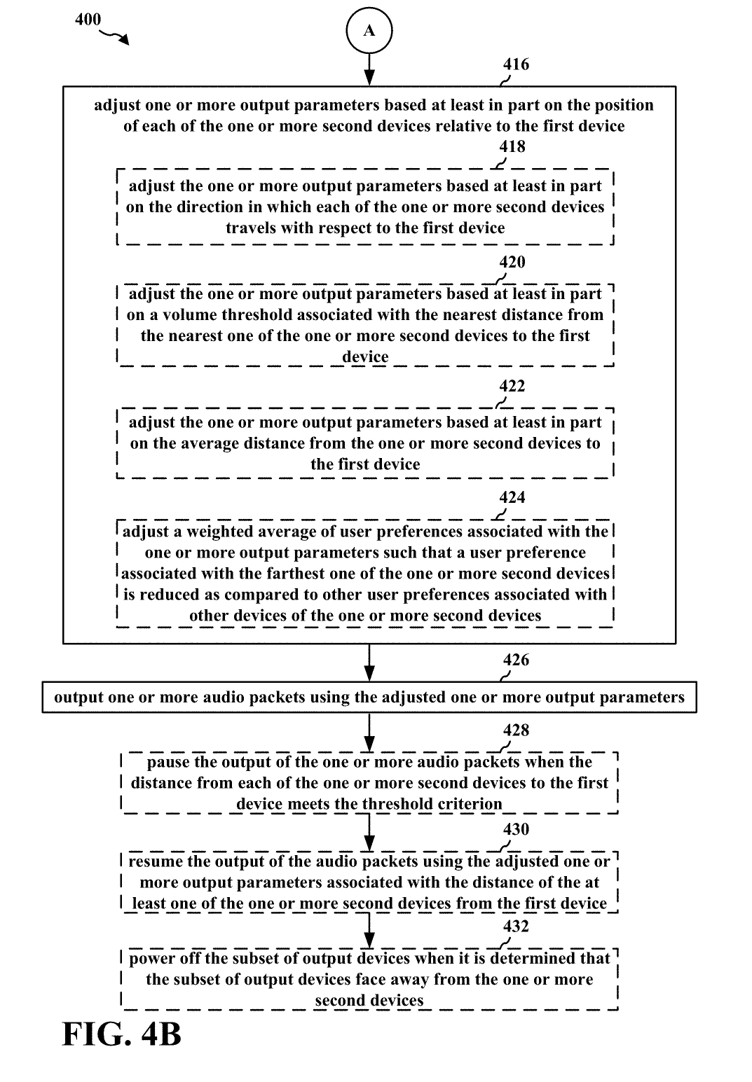

FIGS. 4A and 4B are a flowchart 400 of a method of wireless communication. The method may be performed by a first device (e.g., the central device 102, the wireless device 200, the first device 302a, the apparatus 500/502′) in communication with one or more second devices (e.g., the peripheral device 104, 106, 108, the wireless device 200, the transmitting device 304a, 304b, 304c, the at least one second device 550), a third device (e.g., the third device 112, the wireless device 200, the third device 306, the third device 555), and a fourth device (e.g., the third device 112, the wireless device 200, the fourth device 302b, the fourth device 560). In FIGS. 4A and 4B, optional operations are indicated with dashed lines.

Referring to FIG. 4A, at 402, the first device may receive one or more audio packets from a third device. For example, referring to FIG. 3, the first device 302a may receive a signal 301 from the third device 306. The signal 301 may include one or more audio packets that may be output by the first device 302a. In certain configurations, the signal 301 may include more than one signal. Additionally and/or alternatively, the first device 302a may receive the audio packets from one or more of the transmitting devices 304a, 304b, 304c.

At 404, the first device may receive at least one signal from one or more second devices. In certain aspects, the at least one signal may be received via a short-range communication protocol. For example, referring to FIG. 3, the first device 302a may receive a tracking signal 303a, 303b, 303c from each of the transmitting devices 304a, 304b, 304c. The tracking signals 303a, 303b, 303c may be communicated using BT and/or BLE communications, and may be used by the first device 302a and/or the fourth device 302b to track a position of the transmitting devices 304a, 304b, 304c. In certain configurations, each of the tracking signals 303a, 303b, 303c may indicate a respective transmit power level that is used by the transmitting devices 304a, 304b, 304c when sending the tracking signals 303a, 303b, 303c. In certain configurations, each of the tracking signals 303a, 303b, 303c may also include audio packets that may be output by the first device 302a and/or fourth device 302b.

At 406, the first device may determine a position of each of the one or more second devices relative to the first device based at least in part on a reference vector associated with each of the at least one signal and a reference point associated with either the first device or each of the one or more second devices. In certain aspects, the reference vector associated with each of the at least one signal may include at least one of an AoA at the first device or an AoD from each of the one or more second devices. In certain other aspects, the reference vector associated with each of the at least one signal may include at least one of a transmit power level or a RSSI. For example, referring to FIG. 3, using the received tracking signals 303a, 303b, 303c, the first device 302a may determine a position of each of the transmitting devices 304a, 304b, 304c relative to the first device 302a. For example, the positions may be determined based at least in part on a reference vector (e.g., AoA, AoD, direction, RSSI, transmit power level, etc.) associated with each of the tracking signals 303a, 303b, 303c, and a reference point 310 (e.g., a midline) associated with the first device 302a. Additionally and/or alternatively, a reference point (not shown in FIG. 3) associated with each of the transmitting devices 304a, 304b, 304c may be used in combination with the reference vector to determine the respective positions of the transmitting devices 304a, 304b, 304c.

At 408, the first device may determine the position of each of the one or more second devices by determining a direction in which each of the one or more second devices travels with respect to the first device based at least in part on at least one of the AoA associated with each of the at least one signal or the AoD associated with each of the at least one signal. For example, referring to FIG. 3, the first device 302a may determine a direction (e.g., angular direction) in which each of the transmitting devices 304a, 304b, 304c travels with respect to the first device 302a based at least in part on at least one of the AoA and/or the AoD.

At 410, the first device may determine the position of each of the one or more second devices by determining a distance from each of the one or more second devices to the first device based at least in part on one or more of the transmit power level associated with each of the at least one signal or the RSSI associated with each of the at least one signal. In certain aspects, the distance from each of the one or more second devices to the first device may include an average distance from the one or more second devices to the first device. In certain other aspects, the distance from each of the one or more second devices to the first device may include a farthest distance from a farthest one of the one or more second devices to the first device. In certain other aspects, the distance from each of the one or more second devices to the first device may include a nearest distance from a nearest one of the one or more second devices to the first device. In certain other aspects, the distance from each of the one or more second devices to the first device may meet a threshold criterion. For example, referring to FIG. 3, determine the position of each of the transmitting devices 304a, 304b, 304c by determining a respective distance to each of the transmitting devices 304a, 304b, 304c based at least in part on one or more of the transmit power level and/or the RSSI. The RSSI associated with each of the tracking signals 303a, 303b, 303c may be determined based on the signal power that is detected by the first device 302a. In certain configurations, the respective transmit power level that is indicated by each of the tracking signals 303a, 303b, 303c as well as the signal power may be used to determine the RSSI. The first device 302a may access a look-up table that correlates distances to RSSIs in order to determine the distances of the transmitting devices 304a, 304b, 304c. Additionally and/or alternatively, the RSSI may be used to indicate a linear direction that a listener is moving with respect to the first device 302a. For example, if at time t₀, the first device 302a determines the first tracking signal 303a has an RSSI equal to 10 for first tracking signal 303a, and at time t₁ the first tracking signal 303a has an RSSI equal to 1, the first device 302a may determine that the first transmitting device 304a is moving towards the first device 302a.

At 412, the first device may determine the position of each of the one or more second devices by determining that the distance of at least one of the one or more second devices no longer meets the threshold criterion. For example, referring to FIG. 3, based on one or more of the determined AoA, AoD, RSSI, and/or transmission power level, the first device 302a may determine that one or more of the transmitting devices 304a, 304b, 304c are outside of the threshold range.

At 414, the first device may determine the position of each of the one or more second devices by determining that a subset of output devices face away from the one or more second devices based at least in part on the AoA or the AoD. For example, referring to FIG. 3, the first device 302a may determine that a subset of output devices (e.g., speakers located at the first device 302a) face away from the transmitting devices 304a, 304b, 304c based at least in part on the AoA (e.g., θ₁, θ₂, θ₃) and/or the AoD (not shown) of the tracking signals 303a, 303b, 303b. Consider, for example, a scenario (not illustrated in FIG. 3) in which the first device 302a includes a first subset of output devices located on a first side and a second subset of output devices located on a second side that is opposite to the first side. In this scenario, when the first device 302a determines (e.g., based on the AoA and/or AoD) that each of the transmitting devices 304a, 304b 304c are located on the first side, the first device 302a may output the audio packets using the first subset of output devices.

Referring to FIG. 4B, at 416, the first device may adjust one or more output parameters based at least in part on the position of each of the one or more second devices relative to the first device. For example, referring to FIG. 3, based on the position determined using one or more of the AoA, AoD, transmit power level, and/or the RSSI, the first device 302a may adjust one or more output parameters used for outputting the audio packets. For example, the one or more output parameters may be adjusted based at least in part on the angular direction and/or linear direction in which each of the transmitting devices 304a, 304b, 304c travels with respect to the first device 302a, and/or the distance of each of the transmitting devices 304a, 304b, 304c to the first device 302a. The first device 302a may adjust the output parameters (e.g., volume, the set or subset of output devices used to output the audio packets, the gain, the equalization, the bass level, the treble level, etc.) based on a look-up table that includes a correlation of angular direction, linear direction, and/or distance to various output parameters. The look-up table may be maintained at the first device 302a or remote from the first device 302a.

At 418, the first device may adjust the one or more output parameters based at least in part on the position of each of the one or more second devices relative to the first device by adjusting the one or more output parameters based at least in part on the direction in which each of the one or more second devices travels with respect to the first device. For example, referring to FIG. 3, if at time t₀, the first device 302a determines that the first transmitting device 304a is 20 feet away, the second transmitting device is 35 feet away, and that the third transmitting device 304c is 55 feet away, the first device 302a may output the audio packets at a volume level v₂₀ correlated with a distance of 20 feet. If at time t₁, the first device 302a determines that the first transmitting device 304a is 10 feet away, the second transmitting device remains 35 feet away, and that the third transmitting device 304c remains 55 feet away, the first device 302a may adjust the volume of the audio packets to volume level v₁₀ correlated with a distance of 10 feet, where v₁₀<v₂₀. By reducing the volume level used to output the audio packets when the first transmitting device 304a (e.g., the first listener) moves closer to the first device 302a, listener moving closer to the first device 302a may not perceive the output of the audio packets as being too loud, and hence, the sound quality perceived by the listener moving towards the first device 302a may be improved.

At 420, the first device may adjust the one or more output parameters based at least in part on the position of each of the one or more second devices relative to the first device by adjusting the one or more output parameters based at least in part on a volume threshold associated with the nearest distance from the nearest one of the one or more second devices to the first device. For example, referring to FIG. 3, if at time t₀, the first device 302a determines that the first transmitting device 304a is 20 feet away, the second transmitting device is 35 feet away, and that the third transmitting device 304c is 55 feet away, the first device 302a may output the audio packets at a volume level v₂₀ correlated with a distance of 20 feet. If at time t₁, the first device 302a determines that the first transmitting device 304a is 10 feet away, the second transmitting device remains 35 feet away, and that the third transmitting device 304c remains 55 feet away, the first device 302a may adjust the volume of the audio packets to volume level v₁₀ correlated with a distance of 10 feet, where v₁₀<v₂₀. By reducing the volume level used to output the audio packets when the first transmitting device 304a (e.g., the first listener) moves closer to the first device 302a, the nearest listener may not perceive the output of the audio packets as being too loud, and hence, the sound quality perceived by the nearest listener may be improved.

At 422, the first device may adjust the one or more output parameters based at least in part on the position of each of the one or more second devices relative to the first device by adjusting the one or more output parameters based at least in part on the average distance from the one or more second devices to the first device. For example, referring to FIG. 3, if at time t₀, the first device 302a determines that the average distance to the transmitting devices 304a, 304b, 304b is 55 feet, the first device 302a may output the audio packets at one or more of a volume level v₅₅, a gain level g₅₅, an equalization level e₆₅, a bass level b₆₅, and/or a treble level s₆₅ correlated with a distance of 55 feet. If at time t₁, the first device 302a determines that the average distance to the transmitting devices 304a, 304b, 304b is now 50 feet, the first device 302a may adjust the output parameters of the audio packets to a volume level v₅₀, a gain level g₅₀, an equalization level e₅₀, a bass level b₅₀, and/or a treble level s₅₀ correlated with a distance of 50 feet, where v₅₀<v₅₅, g₅₀≠g₅₅, e₅₀≠e₅₅, b₅₀≠b₅₅, and s₅₀≠s₅₅. By adjusting the output parameters of the audio packets when the average distance between the transmitting devices 304a, 304b, 304c (e.g., a first listener, a second listener, and a third listener) and the first device 302a changes, the sound quality perceived by the listeners may be improved.

At 424, the first device may adjust the one or more output parameters based at least in part on the position of each of the one or more second devices relative to the first device by adjusting a weighted average of user preferences associated with the one or more output parameters such that a user preference associated with the farthest one of the one or more second devices is reduced as compared to other user preferences associated with other devices of the one or more second devices. For example, referring to FIG. 3, if at time t₀, the first device 302a determines that the first transmitting device 304a is 20 feet away, the second transmitting device is 30 feet away, and the third transmitting device 304c is 50 feet away, the first device 302a may apply a weighted value of 5 to the output parameters associated with the first transmitting device 304a, a weighted value of 3.33 to the output parameters associated with the second transmitting device 304b, and a weighted value of 2 to the output parameters associated with the third transmitting device 304c when determining a weighted average of the output parameters. If at time t₁, the first device 302a determines that the first transmitting device 304a is 10 feet away, the second transmitting device remains 30 feet away, and the third transmitting device 304c is 70 feet away, the first device 302a may apply a weighted value of 10 to the output parameters associated with the first transmitting device 304a, a weighted value of 3.33 to the output parameters associated with the second transmitting device 304b, and a weighted value of 1.42 to the output parameters associated with the third transmitting device 304c when determining a weighted average of the output parameters. By adjusting the output parameters of the audio packets using a weighted average based on the respective distances to the transmitting devices 304a, 304b, 304c (e.g., a first listener, a second listener, and a third listener), a larger number of listeners may not perceive the output of the audio packets as being too loud, too quiet, or having dissonant frequencies, and hence, an increase in sound quality perceived by the group of listeners may be achieved.

At 426, the first device may output one or more audio packets using the adjusted one or more output parameters. In certain aspects, the one or more output parameters may include at least one of volume, gain, or equalization. For example, referring to FIG. 3, the first device 302a may output audio packets received via signal 301 from the third device 306.

At 428, the first device may pause the output of the one or more audio packets when the distance from each of the one or more second devices to the first device meets the threshold criterion. For example, referring to FIG. 3, when the first device 302a determines that all of the transmitting devices 304a, 304b, 304c are outside of the threshold range (e.g., the audio output may be inaudible to the listeners), the first device 302a may pause the output of the audio packets received by the third device 306.

At 430, the first device may resume the output of the audio packets using the adjusted one or more output parameters associated with the distance of the at least one of the one or more second devices from the first device. For example, referring to FIG. 3, once the first device 302a determines that at least one of the transmitting devices 304a, 304b, 304c returns within the threshold range, the first device 302a may resume the output of the audio packets using the adjusted one or more output parameters associated with the distance of the at least one transmitting devices 304a, 304b, 304c from the first device 302a.

At 432, the first device may power off the subset of output devices when it is determined that the subset of output devices face away from the one or more second devices. For example, referring to FIG. 3, the first device 302a may determine that a subset of output devices (e.g., speakers located at the first device 302a) face away from the transmitting devices 304a, 304b, 304c based at least in part on the AoA (e.g., θ₁, θ₂, θ₃) and/or the AoD (not shown) of the tracking signals 303a, 303b, 303b. Consider, for example, a scenario (not illustrated in FIG. 3) in which the first device 302a includes a first subset of output devices located on a first side and a second subset of output devices located on a second side that is opposite to the first side. In this scenario, when the first device 302a determines (e.g., based on the AoA and/or AoD) that each of the transmitting devices 304a, 304b 304c are located on the first side, the first device 302a may output the audio packets using the first subset of output devices, and power off the second subset of output devices in order to conserve battery power.

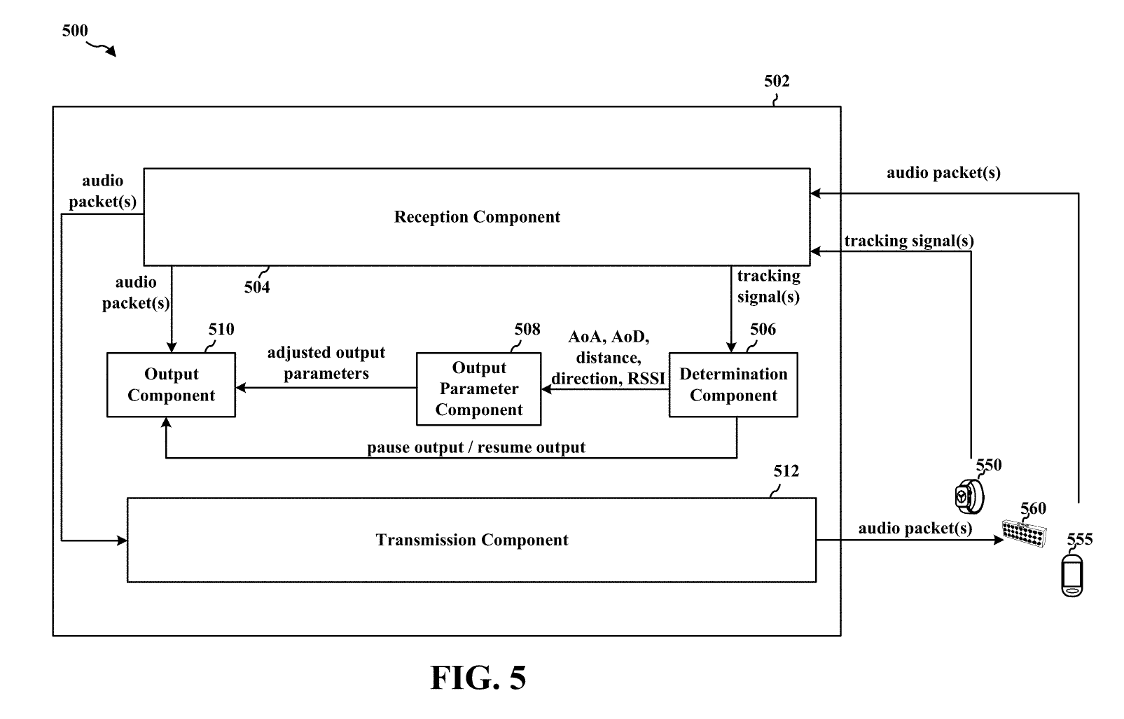

FIG. 5 is a conceptual data flow diagram 500 illustrating the data flow between different means/components in an exemplary apparatus 502. The apparatus may be a first device (e.g., the central device 102, the wireless device 200, the first device 302a, the apparatus 502′) in communication with one or more second devices 550 (e.g., the peripheral device 104, 106, 108, the wireless device 200, the transmitting devices 304a, 304b, 304c), a third device 555 (e.g., the peripheral device 104, 106, 108, the wireless device 200, the third device 306), and a fourth device 560 (e.g., the third device 112, the wireless device 200, the fourth device 302b). The apparatus may include a reception component 504, a determination component 506, an output parameter component 508, an output component 510, and a transmission component 512.

In certain configurations, the reception component 504 may be configured to receive one or more audio packets from the third device 555. The reception component 504 may be configured to send a signal associated with the received audio packets to the output component 510 and/or the transmission component 512. The output component 510 may be configured to output the audio packets. The transmission component 512 may be configured to transmit the audio packets to the fourth device 560 when the output component 510 is powered off.

In certain other configurations, the reception component 504 may be configured to receive at least one signal (e.g., tracking signal(s)) from the one or more second devices 550. In certain aspects, the at least one signal may be received via a short-range communication protocol (e.g., BT protocol, BLE protocol, Wi-Fi protocol, etc.). The reception component 504 may be configured to send the at least one signal to the determination component 506.

In certain other configurations, the determination component 506 may be configured to determine a position of each of the one or more second devices relative to the first device based at least in part on a reference vector associated with each of the at least one signal and a reference point associated with either the first device or each of the one or more second devices. In certain aspects, the reference vector associated with each of the at least one signal may include at least one of an AoA at the first device or an AoD from each of the one or more second devices. In certain other aspects, the reference vector associated with each of the at least one signal may include at least one of a transmit power level or a RSSI.

In certain implementations, the determination component 506 may be configured to determine the position of each of the one or more second devices by determining a direction in which each of the one or more second devices travels with respect to the first device based at least in part on at least one of the AoA associated with each of the at least one signal or the AoD associated with each of the at least one signal.

In certain other implementations, the determination component 506 may be configured to determine the position of each of the one or more second devices by determining a distance from each of the one or more second devices to the first device based at least in part on one or more of the transmit power level associated with each of the at least one signal or the RSSI associated with each of the at least one signal. In certain aspects, the distance from each of the one or more second devices to the first device may include an average distance from the one or more second devices to the first device. In certain other aspects, the distance from each of the one or more second devices to the first device may include a farthest distance from a farthest one of the one or more second devices to the first device. In certain other aspects, the distance from each of the one or more second devices to the first device may include a nearest distance from a nearest one of the one or more second devices to the first device. In certain other aspects, the distance from each of the one or more second devices to the first device may meet a threshold criterion.

In certain other implementations, the determination component 506 may be configured to determine the position of each of the one or more second devices by determining that the distance of at least one of the one or more second devices no longer meets the threshold criterion.

In certain other implementations, the determination component 506 may be configured to determine the position of each of the one or more second devices by determining that a subset of output devices face away from the one or more second devices based at least in part on the AoA or the AoD.

The determination component 506 may be configured to send a signal associated with one or more of the determine AoA, AoD, RSSI, position, distance, and/or transmission power level to the output parameter component 508.

In certain configurations, the output parameter component 508 may be configured to adjust one or more output parameters based at least in part on the position of each of the one or more second devices 550 relative to the first device.

In certain implementations, the output parameter component 508 may be configured to adjust the one or more output parameters based at least in part on the position of each of the one or more second devices 550 relative to the first device by adjusting the one or more output parameters based at least in part on the direction in which each of the one or more second devices travels with respect to the first device.

In certain other implementations, the output parameter component 508 may be configured to adjust the one or more output parameters based at least in part on the position of each of the one or more second devices 550 relative to the first device by adjusting the one or more output parameters based at least in part on a volume threshold associated with the nearest distance from the nearest one of the one or more second devices 550 to the first device.

In certain other implementations, the output parameter component 508 may be configured to adjust the one or more output parameters based at least in part on the position of each of the one or more second devices 550 relative to the first device by adjusting the one or more output parameters based at least in part on the average distance from the one or more second devices 550 to the first device.

In certain other implementations, the output parameter component 508 may be configured to adjust the one or more output parameters based at least in part on the position of each of the one or more second devices 550 relative to the first device by adjusting a weighted average of user preferences associated with the one or more output parameters such that a user preference associated with the farthest one of the one or more second devices 550 is reduced as compared to other user preferences associated with other devices of the one or more second devices 550.

The output parameter component 508 may be configured to send a signal associated with the adjusted output parameter(s) to the output component 510.

In certain configurations, the output component 510 may be configured to output one or more audio packets using the adjusted one or more output parameters. In certain aspects, the one or more output parameters may include at least one of volume, gain, or equalization.

In certain other configurations, the determination component 506 may be configured to send a signal instructing the output component 510 to pause the audio output upon determining that the one or more second devices 550 meet a threshold criterion (e.g., are outside of the threshold range of the first device). In certain other configurations, the determination component 506 may be configured to send a signal instructing the output component 510 to resume the audio output upon determining that the one or more second devices 550 no longer meet the threshold criterion (e.g., are within the threshold range of the first device). In certain other configurations, the determination component 506 may be configured to send a signal instructing the output component 510 to power off the subset of output devices upon determining that the subset of output devices face away from the one or more second devices 550.

In certain other configurations, the output component 510 may be configured to pause the output of the one or more audio packets when the distance from each of the one or more second devices 550 to the first device meets the threshold criterion.

In certain other configurations, the output component 510 may be configured to resume the output of the audio packets using the adjusted one or more output parameters associated with the distance of the at least one of the one or more second devices 550 from the first device.

The apparatus may include additional components that perform each of the blocks of the algorithm in the aforementioned flowcharts of FIGS. 4A and 4B. As such, each block in the aforementioned flowcharts of FIGS. 4A and 4B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

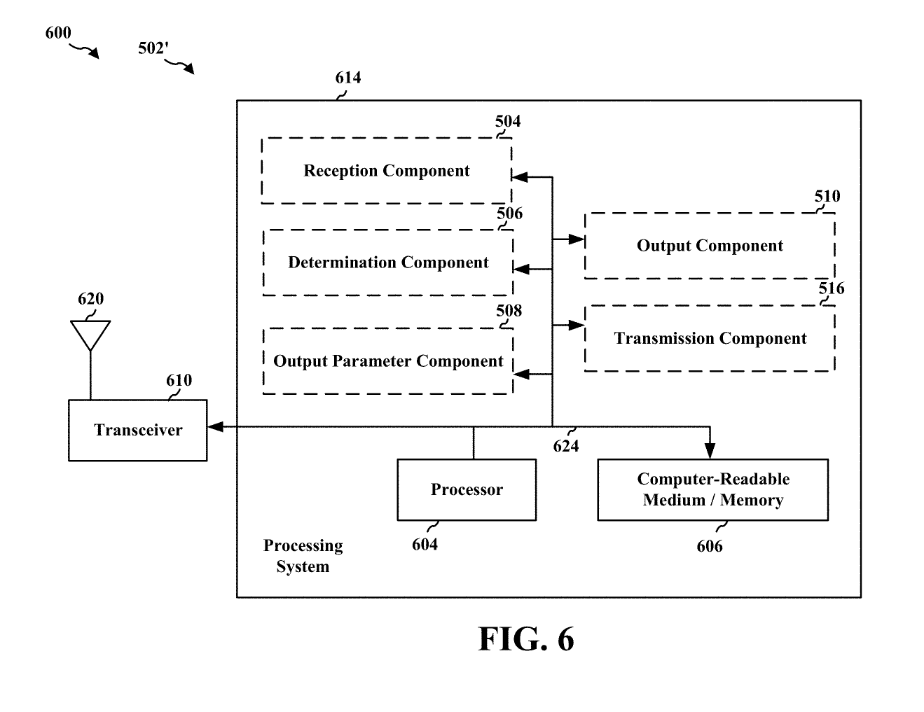

FIG. 6 is a diagram 600 illustrating an example of a hardware implementation for an apparatus 502′ employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware components, represented by the processor 604, the components 504, 506, 508, 510, 512 and the computer-readable medium/memory 606. The bus 624 may also link various other circuits such as timing sources, peripherals, voltage regulators, and power management circuits, which are well known in the art, and therefore, will not be described any further.

The processing system 614 may be coupled to a transceiver 610. The transceiver 610 is coupled to one or more antennas 620. The transceiver 610 provides a means for communicating with various other apparatus over a transmission medium. The transceiver 610 receives a signal from the one or more antennas 620, extracts information from the received signal, and provides the extracted information to the processing system 614, specifically the reception component 504. In addition, the transceiver 610 receives information from the processing system 614, specifically the transmission component 512, and based on the received information, generates a signal to be applied to the one or more antennas 620. The processing system 614 includes a processor 604 coupled to a computer-readable medium/memory 606. The processor 604 is responsible for general processing, including the execution of software stored on the computer-readable medium/memory 606. The software, when executed by the processor 604, causes the processing system 614 to perform the various functions described supra for any particular apparatus. The computer-readable medium/memory 606 may also be used for storing data that is manipulated by the processor 604 when executing software. The processing system 614 further includes at least one of the components 504, 506, 508, 510, 512. The components may be software components running in the processor 604, resident/stored in the computer readable medium/memory 606, one or more hardware components coupled to the processor 604, or some combination thereof.

In certain configurations, the apparatus 502/502′ for wireless communication may include means for receiving one or more audio packets from a third device. In certain other configurations, the apparatus 502/502′ for wireless communication may include means for receiving at least one signal from one or more second devices. In certain aspects, the at least one signal may be received via a short-range communication protocol. In certain other configurations, the apparatus 502/502′ for wireless communication may include means for determining a position of each of the one or more second devices relative to the first device based at least in part on a reference vector associated with each of the at least one signal and a reference point associated with either the first device or each of the one or more second devices. In certain aspects, the reference vector associated with each of the at least one signal may include at least one of an AoA at the first device or an AoD from each of the one or more second devices. In certain other aspects, the reference vector associated with each of the at least one signal may include at least one of a transmit power level or a RSSI. In certain aspects, the means for determining the position of each of the one or more second devices may be configured to determine a direction in which each of the one or more second devices travels with respect to the first device based at least in part on at least one of the AoA associated with each of the at least one signal or the AoD associated with each of the at least one signal. In certain aspects, the means for determining the position of each of the one or more second devices may be configured to determine a distance from each of the one or more second devices to the first device based at least in part on one or more of the transmit power level associated with each of the at least one signal or the RSSI associated with each of the at least one signal. In certain aspects, the means for determining the position of each of the one or more second devices may be configured to determine that the distance of at least one of the one or more second devices no longer meets the threshold criterion. In certain aspects, the means for determining the position of each of the one or more second devices may be configured to determine that a subset of output devices face away from the one or more second devices based at least in part on the AoA or the AoD. In certain other configurations, the apparatus 502/502′ for wireless communication may include means for adjusting one or more output parameters based at least in part on the position of each of the one or more second devices relative to the first device. In certain aspects, the means for adjusting one or more output parameters based at least in part on the position of each of the one or more second devices relative to the first device may be configured to adjust the one or more output parameters based at least in part on the direction in which each of the one or more second devices travels with respect to the first device. In certain aspects, the means for adjusting one or more output parameters based at least in part on the position of each of the one or more second devices relative to the first device may be configured to adjust the one or more output parameters based at least in part on a volume threshold associated with the nearest distance from the nearest one of the one or more second devices to the first device. In certain aspects, the means for adjusting one or more output parameters based at least in part on the position of each of the one or more second devices relative to the first device may be configured to adjust the one or more output parameters based at least in part on the average distance from the one or more second devices to the first device. In certain aspects, the means for adjusting one or more output parameters based at least in part on the position of each of the one or more second devices relative to the first device may be configured to adjust a weighted average of user preferences associated with the one or more output parameters such that a user preference associated with the farthest one of the one or more second devices is reduced as compared to other user preferences associated with other devices of the one or more second devices. In certain other configurations, the apparatus 502/502′ for wireless communication may include means for outputting one or more audio packets using the adjusted one or more output parameters. In certain aspects, the one or more output parameters may include at least one of volume, gain, or equalization. In certain other configurations, the apparatus 502/502′ for wireless communication may include means for pausing the output of the one or more audio packets when the distance from each of the one or more second devices to the first device meets the threshold criterion. In certain other configurations, the apparatus 502/502′ for wireless communication may include means for resuming the output of the audio packets using the adjusted one or more output parameters associated with the distance of the at least one of the one or more second devices from the first device. In certain other configurations, the apparatus 502/502′ for wireless communication may include means for powering off the subset of output devices when it is determined that the subset of output devices face away from the one or more second devices. The aforementioned means may be the processor(s) 202, the audio/display circuitry 204, the radio 230, the MMU 240, the audio/display 242, the WLAN controller 250, short-range communication controller 252, one or more of the aforementioned components of the apparatus 502 and/or the processing system 614 of the apparatus 502′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication of a first device, comprising:
receiving at least one signal from one or more second devices, the at least one signal being received via a short-range communication protocol;
determining a position of each of the one or more second devices relative to the first device based at least in part on a reference vector associated with each of the at least one signal and a reference point associated with either the first device or each of the one or more second devices;
adjusting one or more output parameters based at least in part on the position of each of the one or more second devices relative to the first device; and
outputting one or more audio packets using the adjusted one or more output parameters.

2. The method of claim 1, wherein the reference vector associated with each of the at least one signal includes at least one of an angle of arrival (AoA) at the first device or an angle of departure (AoD) from each of the one or more second devices, and wherein the determining the position of each of the one or more second devices further comprises:
determining a direction in which each of the one or more second devices travels with respect to the first device based at least in part on at least one of the AoA associated with each of the at least one signal or the AoD associated with each of the at least one signal.

3. The method of claim 2, wherein the adjusting the one or more output parameters based at least in part on the position of each of the one or more second devices relative to the first device comprises:
adjusting the one or more output parameters based at least in part on the direction in which each of the one or more second devices travels with respect to the first device.

4. The method of claim 2, wherein the reference vector associated with each of the at least one signal includes at least one of a transmit power level or a received signal strength indicator (RSSI), and wherein the determining the position of each of the one or more second devices further comprises:
determining a distance from each of the one or more second devices to the first device based at least in part on one or more of the transmit power level associated with each of the at least one signal or the RSSI associated with each of the at least one signal.

5. The method of claim 4, wherein the distance from each of the one or more second devices to the first device includes a nearest distance from a nearest one of the one or more second devices to the first device.

6. The method of claim 5, wherein the adjusting the one or more output parameters based at least in part on the position of each of the one or more second devices relative to the first device comprises:
adjusting the one or more output parameters based at least in part on a volume threshold associated with the nearest distance from the nearest one of the one or more second devices to the first device.

7. The method of claim 4, wherein the distance from each of the one or more second devices to the first device includes an average distance from the one or more second devices to the first device.

8. The method of claim 7, wherein the adjusting the one or more output parameters based at least in part on the position of each of the one or more second devices relative to the first device comprises:
adjusting the one or more output parameters based at least in part on the average distance from the one or more second devices to the first device.

9. The method of claim 4, wherein the distance from each of the one or more second devices to the first device includes a farthest distance from a farthest one of the one or more second devices to the first device.

10. The method of claim 9, wherein the adjusting the one or more output parameters based at least in part on the position of each of the one or more second devices relative to the first device comprises:
adjusting a weighted average of user preferences associated with the one or more output parameters such that a user preference associated with the farthest one of the one or more second devices is reduced as compared to other user preferences associated with other devices of the one or more second devices.

11. The method of claim 4, wherein the distance from each of the one or more second devices to the first device meets a threshold criterion.

12. The method of claim 11, further comprising:
pausing the output of the one or more audio packets when the distance from each of the one or more second devices to the first device meets the threshold criterion.

13. The method of claim 12, wherein the determining the position of each of the one or more second devices further comprises:
determining that the distance of at least one of the one or more second devices no longer meets the threshold criterion.

14. The method of claim 13, further comprising:
resuming the output of the audio packets using the adjusted one or more output parameters associated with the distance of the at least one of the one or more second devices from the first device.

15. The method of claim 2, wherein the determining the position of each of the one or more second devices further comprises:
determining that a subset of output devices face away from the one or more second devices based at least in part on the AoA or the AoD.

16. The method of claim 15, further comprising:
powering off the subset of output devices when it is determined that the subset of output devices face away from the one or more second devices.

17. The method of claim 1, wherein the one or more output parameters includes at least one of volume, gain, or equalization.

18. The method of claim 1, further comprising:
receiving the one or more audio packets from a third device.

19. An apparatus for wireless communication of a first device, comprising:
a memory; and
at least one processor coupled to the memory and configured to:
receive at least one signal from one or more second devices, the at least one signal being received via a short-range communication protocol;
determine a position of each of the one or more second devices relative to the first device based at least in part on a reference vector associated with each of the at least one signal and a reference point associated with either the first device or each of the one or more second devices;
adjust one or more output parameters based at least in part on the position of each of the one or more second devices relative to the first device; and
output one or more audio packets using the adjusted one or more output parameters.

20. The apparatus of claim 19, wherein the reference vector associated with each of the at least one signal includes at least one of an angle of arrival (AoA) at the first device or an angle of departure (AoD) from each of the one or more second devices, and wherein the at least one processor is configured to determine the position of each of the one or more second devices by:
determining a direction in which each of the one or more second devices travels with respect to the first device based at least in part on at least one of the AoA associated with each of the at least one signal or the AoD associated with each of the at least one signal.

21. The apparatus of claim 20, wherein the at least one processor is configured to adjust the one or more output parameters based at least in part on the position of each of the one or more second devices relative to the first device by:
adjusting the one or more output parameters based at least in part on the direction in which each of the one or more second devices travels with respect to the first device.

22. The apparatus of claim 20, wherein the reference vector associated with each of the at least one signal includes at least one of a transmit power level or a received signal strength indicator (RSSI), and wherein the at least one processor is configured to determine the position of each of the one or more second devices by:
determining a distance from each of the one or more second devices to the first device based at least in part on one or more of the transmit power level associated with each of the at least one signal or the RSSI associated with each of the at least one signal.

23. The apparatus of claim 22, wherein the distance from each of the one or more second devices to the first device includes a nearest distance from a nearest one of the one or more second devices to the first device.

24. The apparatus of claim 23, wherein the at least one processor is configured to adjust the one or more output parameters based at least in part on the position of each of the one or more second devices relative to the first device by:
adjusting the one or more output parameters based at least in part on a volume threshold associated with the nearest distance from the nearest one of the one or more second devices to the first device.

25. The apparatus of claim 22, wherein the distance from each of the one or more second devices to the first device includes an average distance from the one or more second devices to the first device.

26. The apparatus of claim 25, wherein the at least one processor is configured to adjust the one or more output parameters based at least in part on the position of each of the one or more second devices relative to the first device by:
adjusting the one or more output parameters based at least in part on the average distance from the one or more second devices to the first device.

27. The apparatus of claim 22, wherein the distance from each of the one or more second devices to the first device includes a farthest distance from a farthest one of the one or more second devices to the first device.

28. The apparatus of claim 27, wherein the at least one processor is configured to adjust the one or more output parameters based at least in part on the position of each of the one or more second devices relative to the first device by:
adjusting a weighted average of user preferences associated with the one or more output parameters such that a user preference associated with the farthest one of the one or more second devices is reduced as compared to other user preferences associated with other devices of the one or more second devices.

29. An apparatus for wireless communication of a first device, comprising:
means for receiving at least one signal from one or more second devices, the at least one signal being received via a short-range communication protocol;
means for determining a position of each of the one or more second devices relative to the first device based at least in part on a reference vector associated with each of the at least one signal and a reference point associated with either the first device or each of the one or more second devices;
means for adjusting one or more output parameters based at least in part on the position of each of the one or more second devices relative to the first device; and
means for outputting one or more audio packets using the adjusted one or more output parameters.

30. A non-transitory computer-readable medium storing computer executable code of a first device, comprising code to:
receive at least one signal from one or more second devices, the at least one signal being received via a short-range communication protocol;
determine a position of each of the one or more second devices relative to the first device based at least in part on a reference vector associated with each of the at least one signal and a reference point associated with either the first device or each of the one or more second devices;
adjust one or more output parameters based at least in part on the position of each of the one or more second devices relative to the first device; and
output one or more audio packets using the adjusted one or more output parameters.
